(19) United States
(12) Patent Application Publication
(10) Pub. No.: US 2001/0010685 A1
(43) Pub. Date: Aug. 2, 2001

(54) Method and a device for transferring capability information

(75) Inventor: Outi Aho, Lempaala (FI)

Correspondence Address: Perman & Green, 425 Post Road, Fairfield, CT, 06430-6232, US

(73) Assignee: Nokia MObile Phones Ltd.

(21) Appl. No.: 09/774,308

(22) Filed: Jan. 31, 2001

(30) Foreign Application Priority Data
Feb. 1, 2000 (FI) 20000213

(51) Int. Cl. H04Q 7/00; H04J 3/16; H04L 12/56; H04L 12/28

(52) U.S. Cl. 370/329; 370/466; 370/352; 370/401

(57) ABSTRACT

A method and a device for transferring capability information, which method comprises storing (61) the capability information of the device; placing (63) said capability information in the payload part of a message before the message is transferred to a protocol stack, the method comprising a header part and a payload part; processing (64) the message containing the capability information according to a specific protocol stack; and transmitting (65) said message.

### FIELD OF THE INVENTION

The present invention relates to a method and a device for transferring capability information.

### BACKGROUND OF THE INVENTION

Wireless communication networks and the Internet network are expanding at a brisk pace, and the number of their users is increasing rapidly. Bringing advanced Internet services to digital mobile stations of wireless communication networks, such as to so-called media phones, is possible, for example, with the help of WAP technology. WAP (Wireless Application Protocol) is an open standard designed to globally support the majority of digital wireless communication networks, such as GSM (Global System for Mobile Communications), GPRS (General Packet Radio Service), PDC (Personal Digital Cellular), CDMA IS-95 (Code Division Multiple Access), TDMA IS-136 (Time Division Multiple Access) and 3^{rd} generation networks, such as WCDMA (Wideband CDMA) and CDMA-2000.

In the WAP system (FIG. 1), a wireless terminal, a mobile station MS, here a so-called WAP terminal, that uses WAP protocol for external communication can communicate with an Internet network server 20. The connection between the WAP terminal and the Internet network is implemented by a WAP gateway 15, which operates as a messaging element between the WAP terminal MS and an Internet network 18. The WAP gateway converts when necessary messages directed by the WAP terminal to the Internet network into messages according to some Internet protocol, such as TCP/IP protocol (Transmission Control Protocol/Internet Protocol). Correspondingly, messages addressed from the Internet network to a wireless network 12, to the WAP terminal MS, are converted when necessary in the WAP gateway into messages according to WAP protocol (e.g. WSP, Wireless Session Protocol). The WAP terminal as such can be any device that uses WAP protocol for external communication, such as a mobile station of a cellular network or a computer terminal, which is in communication with a wireless network, e.g. through a mobile station of a cellular network.

Communication modes supported by WAP intended for information transfer over a radio path are called bearers. These are, among others, in different networks supported by WAP, short messages (Short Message Service), data calls (CSD, Circuit Switched Data) and packet radio, i.e. GPRS services, USSD service (Unstructured Supplementary Service Data), as well as other bearers defined in the WAP specifications.

As for its protocols, the WAP system is a hierarchic system. Both a WAP terminal and a WAP gateway comprise a programmably implemented WAP protocol stack comprising specific WAP protocol layers. WAP protocol layers are, among others, a WSP layer (Wireless Session Protocol), a WTP layer (Wireless Transaction Protocol), a WTLS layer (Wireless Transport Layer Security) and a WDP layer (Wireless Datagram Protocol). The corresponding WAP protocol layers of a WAP terminal and a WAP gateway communicate with each other for implementing reliable data transfer between the WAP terminal and the WAP gateway over a specific bearer.

A user of a computer terminal that is in communication with the Internet network has already a long time had an opportunity to retrieve multimedia components, such as short video clips and audio clips that are in an electronic format, into his computer terminal from some Internet network server. As data transfer rates accelerate and the capabilities of mobile stations improve, an interest has now also been awakened in multimedia messages in a wireless network.

In a wireless network, the difference of the physical and programmable capabilities of terminals become a problem. One terminal has a large colour display, whereas the other has a small black-and-white display. One terminal is capable of opening files packed in a specific manner, while the other one does not. There are numerous differences that influence what type of information and in what type of format a device is capable of receiving and processing. For example, it is not worth transmitting picture or video to a terminal that is incapable for presenting the picture or video.

For situations like this, the WAP Forum has specified in its UAPROF (User Agent Profile Specification, www.wapforum.org) a so-called capability negotiation. Basically, in this capability negotiation, when initiating a session a terminal communicates to a gateway which MIMEs (Multipurpose Internet Mail Extensions) it supports and the maximum message size it can receive. In connection with informing of capabilities, information is transmitted from the wireless terminal to a multimedia messaging service system on the capabilities of the wireless terminal and a multimedia messaging client used therein. These capabilities can be divided roughly into four different groups: 1) hardware capabilities; 2) software capabilities; 3) User Agent capabilities; and 4) multimedia message-specific special capabilities. For example, when the user starts browsing multimedia information, the user's terminal initialises a WSP session by sending to the gateway a “WSP Connect” request. In the same connection set-up process, the terminal also informs its capability information by using the Profile and Profile-Diff header fields in the “WSP-Connect” request. In these header fields, it encodes the capability information by using WBXML encoding (Binary XML (Extensible Markup Language) Specification, www.wapforum.org). During the WSP session, the user may request the gateway to transfer to him content from some server. This is effected by transmitting to the gateway a standard WSP request, which the gateway converts, for example, into a format required by http protocol (hyper text transfer protocol) and transmits further to the server attaching to it the information on the capabilities of the user.

Thus, a capability negotiation according to the WAP forum's UAPROF is WSP-session-specific. A multimedia messaging service again is intended to be implemented so that each multimedia message (MM) is sent to a user in its own WSP session, specifically opened for the message in question. This again means in practice that for each multimedia message capability negotiations should be carried out separately with a gateway and as for each multimedia message, the gateway should separately inform a Multimedia Messaging Service Center (MMSC) of the capabilities of the user by converting the data in the WSP header fields sent by the user, for example, into http header fields and by sending these further to the MMSC. The MMSC has to convert/interpret the information in these header fields into a format understood by the server with a separate interpretation program module. However, converting/interpreting with a separate program makes communication between the terminal and the MMSC heavy, because the same operation has to be done in connection with every message. Furthermore, conversion/interpretation errors in different operating environments may become a problem.

### SUMMARY OF THE INVENTION

Now, a method and a device have been invented for transferring capability information, which contributes to and simplifies the transferring of messages in a multimedia messaging system.

According to a first aspect of the invention, there is implemented a device for transferring capability information, comprising means for storing the capability information of the device, means for preparing a message for transmission comprising processing according to a specific protocol stack, means for transmitting a message comprising a header part and a payload part, the device further comprising means for packing the capability information into the payload part of the message before the message is transferred to the protocol stack. In other words, the capability information is thus placed into the payload part over the protocol stack, such as WAP.

According to a second aspect of the invention, there is implemented a method for transferring capability information, which method comprises storing the capability information of a device and packing said capability information into the payload part of a message before the message is transferred to a protocol stack, the message comprising a header part and a payload part, the message comprising the capability information being processed according to a specific protocol stack, and transmitting said message.

According to third aspect of the invention, there is implemented a system for transferring capability information, comprising a terminal (MS) and a multimedia messaging service center (MMSC) for implementing a multimedia messaging service between the terminal and the multimedia messaging service center, furthermore, the terminal comprises means for packing the capability information of the terminal into the payload part of a message passing from the terminal to the multimedia messaging service center before the message is transferred to the used protocol stack, the message comprising a payload part and a header part.

According to a preferred embodiment of the invention, the method and the device are used in a capability negotiation between a terminal (MS) and a multimedia messaging service center (MMSC), relating to the capabilities of the terminal and programs used in the terminal (User Agent) (CPI, Capability and Preference Information). As distinct from the solution according to prior art, the capabilities of the terminal and its software are no longer sent merely to a gateway when setting up a WSP session in the Profile and Profile-Diff header fields of a WSP-Connect request, but the information relating to the capabilities of the terminal is sent directly to the multimedia messaging service center (MMSC) at the application level in the payload part of a frame using separate primitives (e.g. MMS version, MMS max message size, MMS CCPPaccept). Due to this procedure, the MMSC no longer has to separately convert/interpret the user CPI, but it can directly read the CPI information. With the procedure described above, the transferring of messages is significantly lightened and simplified in a multimedia messaging system. As distinct from prior art, with the method that is the object of the invention no additional conversion/interpretation modules are required in the MMSC, but the MMSC is capable of directly reading the CPi information. Hence, raising the capability negotiations from the WSP level to the application level lightens the capability negotiations between a terminal and a multimedia messaging service center considerably. With the procedure according to the application that is the object of the invention, the capability negotiation between the terminal and the MMSC can be carried out separately for each multimedia message or the MMSC can be arranged to store in a memory the information on the capabilities of the terminal and to occasionally check from the terminal the accuracy of the information.

With the invention, a more effective and advantageous way than the solutions presented in the prior art is accomplished to manage communicating capability information from a terminal (MS) through a gateway to a multimedia messaging service center (MMSC), when the multimedia messaging service center no longer has to convert/interpret the CPI information sent by a user. Furthermore, the procedure according to the invention for transferring capability information is also independent of the functioning of protocol layers under the application layer. This gives an advantage that the procedure is not dependent of the protocol used (e.g. WAP), but it can be used with any protocol. When possibly changing someday in the future to use some new protocol, the capability information transferring process does not have to be redesigned, but it can also be applied with new protocols as before.

With the help of the invention, the information relating to the capabilities of the terminal of a user can preferably also be protected by encoding it before sending from the terminal to a gateway. This would not have been possible in an implementation according to prior art, because the information relating to capabilities was sent in header fields that were determined as unencrypted. The encrypted capability information could be, for example, the data relating to a given application, which when falling into the hands of an outsider could cause troubles to the user. The problem does not so much relate to the interface terminal-gateway, which preferably is an air interface, but to a considerable extent to the interface gateway-MMSC, which can be, e.g. an interface implemented over the Internet network. It is easy to interpret capability information converted from WSP header fields into http header fields as unencrypted, captured from a network. When capability information falls into the wrong hands, someone might, for example, on the basis of the information transmit to the terminal false messages in the name of an MMSC claiming, for example, that a new message has arrived or transmit to the MMSC junk mail or similar, addressed to the terminal in question.

Similarly, with the method according to the invention, it is possible to add to the primitive used, in addition to the capabilities of the terminal of the user, also information on the preferences of the user or other similar application-level capabilities, which in an implementation according to prior art should have been implemented with a separate primitive made merely for this purpose. This kind of information relating to user preferences could be, for example, how long the user wants his messages to be stored in the MMSC or something like that. Thus, with the method according to the invention, it is indeed possible to combine separate components which, with a method according to prior art, should have been decentralised and, hence, to lighten the required total structure.

### BRIEF DESCRIPTION OF THE DRAWINGS

In the following, the invention will be described in detail by referring to the enclosed drawings, in which

FIG. 1 shows a common model of the WAP system according to prior art;

FIG. 2 shows a simplified representation according to an embodiment of the invention of the functioning of a method according to the invention, in the form of a time sequence diagram;

FIG. 3 shows a method according to an embodiment of the invention for framing capability information;

FIG. 4 shows as a block diagram a device according to the invention for transferring capability information; and

FIG. 5 shows by means of a flow diagram a preferred embodiment of the method according to the invention for transferring capability information

### DETAILED DESCRIPTION

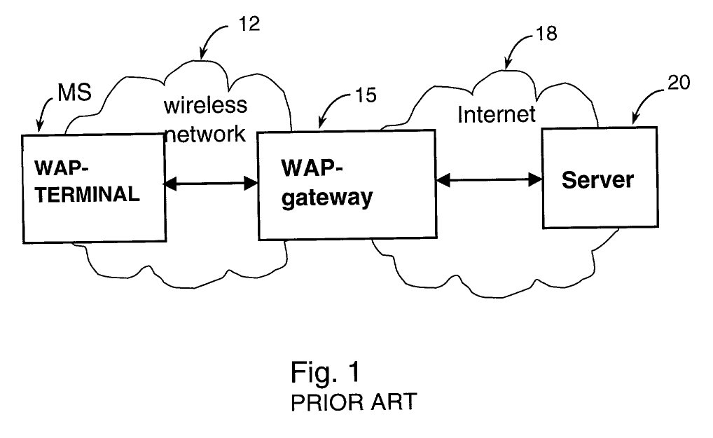

FIG. 1 was described above in more detail in connection with the description of prior art.

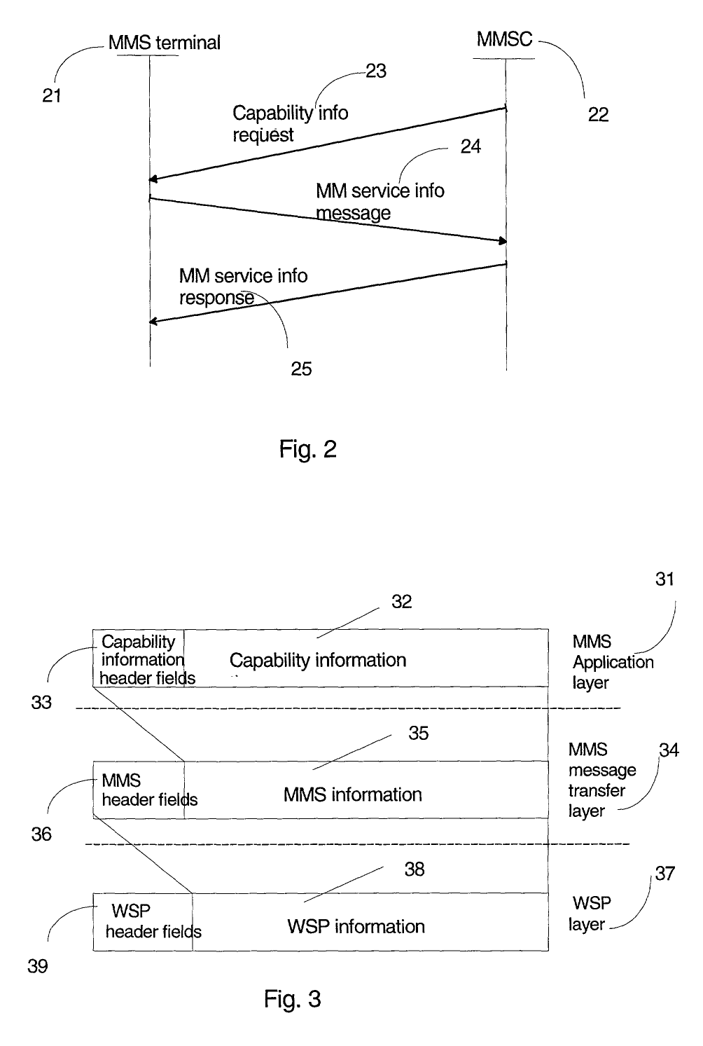

FIG. 2 shows a simplified representation according to an embodiment of the invention of the functioning of a method according to the invention, in the form of a time sequence diagram. There, an MMSC 22 transmits to an MMS terminal 21 (MMS Client, Multimedia Messaging Service Client), i.e. to a terminal, a request 23 for updating the capability information of the terminal. The transmission of a request like this from the MMSC may result, for example, from the MMSC receiving a multimedia message (MM) addressed to the terminal. If the MMSC is arranged to store the capability information of the terminal, the updating of the information can be carried out, for example, at specific intervals or even in connection with setting up a connection between the terminal and the MMSC. After receiving the capability information transmission request, the terminal retrieves the capability information from a memory and frames them in a data transmission frame in the payload part of the application level. After framing, the terminal sends an MM service info message 24 comprising the capability information to the MMSC. After receiving the MM service info message, the MMSC acknowledges the message as received and understood with an MM service info response 25 transmitted to the terminal. The MMS Client can also send to the MMSC an MM Service Info message independently without the MMSC's request (Capability info update) if, for example, some changes of information have taken place in the terminal or, for example, at given intervals agreed in advance.

FIG. 3 shows a method according to an embodiment of the invention for framing capability information. In the method, the actual information relating to a terminal and its user preferences is packed in an MMS application layer 31 into a payload part “Capability information” 32 of a frame. In addition, header fields 33 are attached to the frame, which comprise data transmission information between the applications of the MMS application layer, such as, e.g. information on the description language in which the capability information was transferred, information on the version of the method in question that is being used, information on possible encoding (whether binary coding was used or not), information on whether the information is encrypted in some way and so on. The capability information of the terminal transmitted to the MMSC may comprise, for example, information on the terminal's hardware, such as the capabilities of the display and the size of the memory, information on the terminal's software, information on the terminal's WAP capabilities, information on the capabilities of the terminal's browser, information on the capabilities of the network, etc. The preference information of the user of the terminal again can comprise, for example, information on what type of format the user primarily wants to see his messages in, how long he wants to keep the messages in the MMSC, whether messages equipped with some sender identifier are more important than the other messages and, thus, require special measures and so on. The capability data are packed in the payload part by using separate capability primitives, such as, e.g. MMS version, MMS max message size, MMS CCPPaccept and so on. Furthermore, the payload part can already be encoded in this phase for encrypting the information while it is transferred from the terminal to the MMSC. From the MMS application layer, the framed capability information frame is transferred to a lower layer, to an MMS message transfer layer 34, which in practice means an MMS Message Transfer Agent (MTA), which is a commonly used term, for example, in connection with electronic mail and means the part of the MMS application that is responsible for transmitting a given message to its destination and for receiving a message in the right data transmission format. In this layer, the whole frame of the previous layer is re-framed into a payload part MMS information 35 of the data transmission frame of the MMS message transfer layer. In addition, data transmission information required in data transmission relating to the MMS message transfer layer is added to the new frame, to header fields 36 of the frame. From the MMS message transfer layer, the augmented frame is transferred, for example, to the uppermost protocol level of a WAP protocol stack, to a WSP layer 37, wherein the frame of the upper layer including its header fields is framed into a payload part WSP information 38 of the frame of the WSP layer, and header fields 39 comprising the WSP layer's data transmission information is added to the frame. This is continued until a bearer level is reached with the protocol stack used, whereupon the frame of the lowermost protocol layer is transmitted using a bearer along a physical data transmission interface, such as a radio interface. The figure clearly illustrates the detachment of the transfer of the capability information according to the invention from the protocol stack used. With a solution according to prior art, the capability information would have been packed into the header fields 39 of the WSP layer 37 and, thus, this way of transferring capability information would have been dependent of the protocol used. In the procedure according to the invention, however, the capability information is already packed in the MMS application layer 31, into the payload part 32 of the frame, which procedure ensures independence of the data transmission protocol stack used.

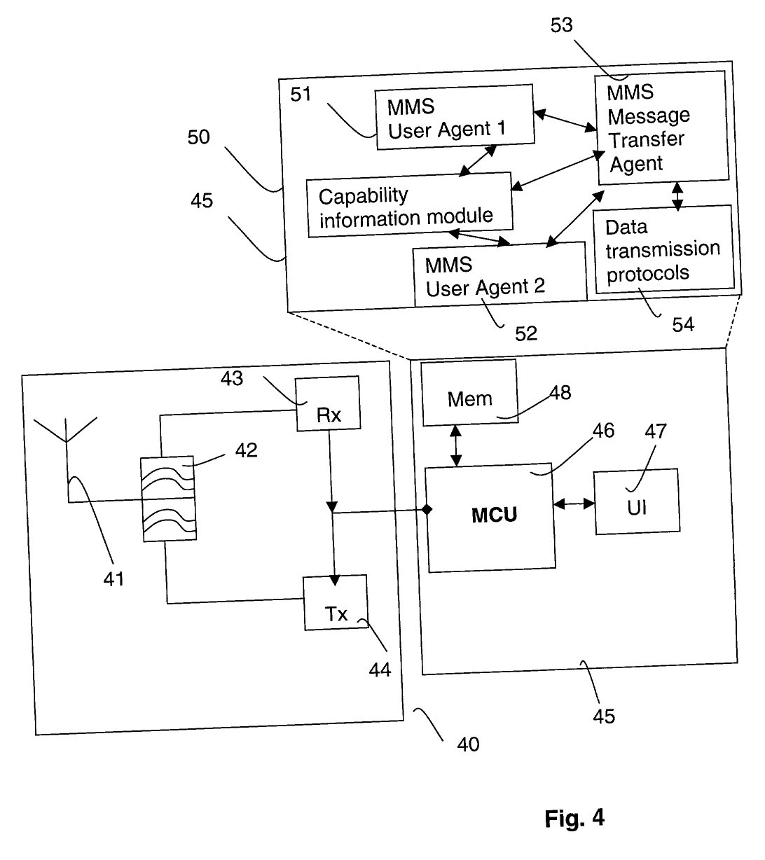

FIG. 4 shows a device according to an embodiment of the invention, which comprises a transceiver part 40 and a device controlling part 45. The transceiver part includes an antenna 41, a Duplex filter 42, a receiving branch 43 and a transmitting branch 44. The transceiver part is connected with a Master Controlling Unit (MCU) 46 located in the device controlling part 45 that controls the other parts, which is, e.g. a microprocessor. The Master Controlling Unit 46 is arranged on the basis of programs stored in a memory unit 48 to communicate when necessary the capability information of the device using a bearer preferably over a radio interface. Lower down, the figure shows the physical block diagram of the device controlling part 45 and upper, the figure shows the functional block diagram of the device controlling part 45. With the programs stored in the memory unit 48, a capability information module 50 is implemented, the function of which is to provide MMS User Agents 51, 52, that are implemented programmably and functionally connected to the capability information module with the information on the capabilities of the device when they so desire. The capability information module takes care of the capability information management of the terminal for all of the applications of the terminal—not only for the MMS service. In practice, the capability information module is a small database, wherein the required capability information is being stored. The MMS User Agent (UA) again is a commonly used term and it means the part of the software of the MMS that is responsible for everything else except the actual transferring and receiving of a message. The User Agent communicates with user interface applications (UI). There can be several MMS User Agents active simultaneously, and it is indeed the preferred function of the capability information module to provide them all in a centralised manner with information on the capabilities of the device, stored in the memory unit 48. With the capability information module, the advantage achieved compared to separate solutions is that when the capability information is updated the updating is effected in a centralised manner for all MMS User Agents. The MMS User Agents 51, 52 are also connected with a programmably implemented MMS Message Transfer agent 53. The MMS Message Transfer agent provides a data transmission interface of the application level between the terminal (MS) and the MMSC. In other words, the applications of the terminal and the MMSC, connected with each other, exchange information with the assistance of the MMS Message Transfer agent. The MMS Message Transfer agent is connected with a programmably implemented data transmission protocol stack 54, e.g. a WAP protocol stack, which takes care of the exchanging of messages in protocol layers, which are lower than the application layer. The capability information module 50 is also connected with a user interface 47 through which the user can change when necessary the information stored in the memory 48 on the terminal's capabilities and user preferences.

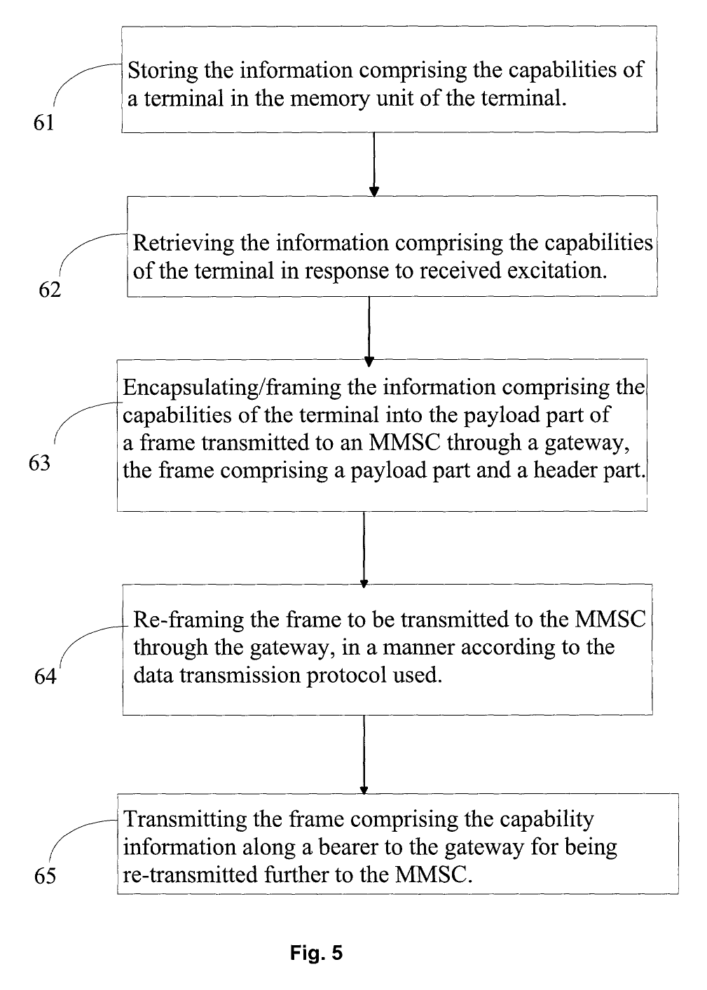

FIG. 5 shows with a flow diagram a preferred embodiment of the method according to the invention for transferring capability information, which method comprises storing in a memory unit 48 of a device the information on the capabilities of the device and when so desired also on the user preferences (step 61). The updating of the information stored in the memory unit can preferably be effected at specific intervals agreed in advance or, for example, when changes are observed in the capabilities of the device, such as closing of applications, detaching or attaching of connectable equipment and such like. The information on the capabilities of the device stored in the memory is retrieved in response to received excitation (step 62). This excitation can preferably be, for example, the MMSC's request for the updating of the capability information of the device registered therein, when the MMSC is without a memory, the MMSC's notification of a new multimedia message or, for example, the opening of a WSP connection to a gateway. Behind the retrieving of the capability information is the capability information module 50, which distributes the capability information in a centralised manner further to the MMS user agents 51, 52 and other similar ones. The updating of the capability information in the MMSC can also preferably be implemented so that the terminal sends, without a separate request, the capability information to the MMSC, for example, when the capability information changes or at specific intervals.

Framing the capability information into the payload part of the data transmission frame of the application level (step 63), the frame being formed of a header part and a payload part. It is to be noted here that because the capability information is framed at the application level in the payload part, the capability information will pass directly to the MMSC and not to the possible gateway in between the terminal and the MMSC. This for part causes that preferably the WSP session-specific capability information negotiations carried out between the terminal and the gateway could be carried out further with the UAProf method presented by the WAP-forum by transferring the capability information in the header fields of a WSP frame. Thus, the UAProf method and the method that is the object of the invention for transferring capability information are not mutually exclusive methods, but their co-use would also be a preferred method for transferring capability information to both the gateway and the MMSC. Also with this procedure, the heavy interpreting/converting of header field information in the MMSC would be avoided.

Re-framing the frame of the application level transmitted to the MMSC through the gateway in a manner according to the data transmission protocol stack 54 used (step 64). For example, a WAP protocol stack comprises four protocol layers (WSP, WTP, WTLS and WDP) in each of which the whole frame of the previous upper protocol layer is packed into the payload part of the frame of the layer in question and adding thereto the header fields of the layer in question before the transfer to a lower protocol layer. In this way, it is proceeded in connection with the transmission through all the protocol layers, from the uppermost to the lowermost.

Transmitting the frame comprising the capability information from the undermost protocol level along a bearer to the gateway for being further transmitted to the MMSC (step 65). The undermost protocol level, for example, in the case of WAP protocol, is WDP from where the frame is transferred to a bearer, such as SMS, GPRS, etc. for being transmitted to preferably over a radio interface to the gateway. The gateway preferably carries out for the transmitted frame the changing of the header fields of the frames, for example, from WAP into http, in which format it preferably transmits the frame, for example, over the Internet to the MMSC.

This paper presents the implementation and embodiments of the present invention, with the help of examples. A person skilled in the art will appreciate that the present invention is not restricted to details of the embodiments presented above, and that the invention can also be implemented in another form without deviating from the characteristics of the invention. The embodiments presented above should be considered illustrative, but not restricting. Thus, the possibilities of implementing and using the invention are only restricted by the enclosed claims. Consequently, the various options of implementing the invention as determined by the claims, including the equivalent implementations, also belong to the scope of the invention.

1. A device for transferring capability information, comprising means for storing the capability information of the device, means for preparing a message for transmission comprising processing according to a specific protocol stack, means for transmitting the message comprising a header part and a payload part, wherein the device further comprises means for packing the capability information into the payload part of the message before the message is transferred to the protocol stack.

2. A device according to claim 1, wherein said data transmission protocol is WAP (Wireless Application Protocol).

3. A device according to claim 1, wherein said message is arranged for being transmitted to a multimedia messaging service center (MMSC).

4. A device according to claim 1, wherein said capability information comprises at least some of the following information:
information on the hardware of a terminal, information on the software of a terminal, information on the WAP capabilities of a terminal, information on the capabilities of the browser of a terminal, information on the capabilities of a network and information on user preferences.

5. A device according to claim 1, wherein said device is a wireless terminal.

6. A device according to claim 1, wherein said device further comprises a user interface for changing the capability information.

7. A method for transferring capability information, which method comprises
storing the capability information of a device, wherein the method comprises
packing said capability information into the payload part of a message before the message is transferred to a protocol stack, the message comprising a header part and a payload part,
processing the message comprising the capability information according to a specific protocol stack, and
transmitting said message.

8. A method according to claim 7, wherein said data transmission protocol is WAP (Wireless Application Protocol).

9. A method according to claim 7, wherein said message is transmitted to a multimedia messaging service center (MMSC).

10. A method according to claim 7, wherein said capability information comprises at least some of the following information:
information on the hardware of a terminal, information on the software of a terminal, information on the WAP capabilities of a terminal, information on the capabilities of the browser of a terminal, information on the capabilities of a network, and information on user preferences.

11. A method according to claim 7, wherein the method comprises transmitting said message over a radio interface to a gateway.

12. A system for transferring capability information, comprising a terminal (MS) and a multimedia messaging service center (MMSC) for implementing a multimedia messaging service between the terminal and the multimedia messaging service center, wherein the terminal comprises means for packing the capability information of the terminal into the payload part of a message that goes from the terminal to the multimedia messaging service center before the message is transferred to the protocol stack used, the message comprising a payload part and a header part.
